(19) United States
(12) Patent Application Publication
(10) Pub. No.: US 2026/0146941 A1
(43) Pub. Date: May 28, 2026

(54) CHARACTERIZATION PROTECTION METHOD FOR TRANSFER FILM OF RING-BLOCK FRICTION PAIR

(71) Applicant: China Academy of Machinery Wuhan Research Institute of Materials Protection Co.,Ltd., Wuhan (CN)

(72) Inventors: Dan Jia, Wuhan (CN); Yiwei Zhou, Wuhan (CN); Haitao Duan, Wuhan (CN); Jian Li, Wuhan (CN); Shengpeng Zhan, Wuhan (CN); Tian Yang, Wuhan (CN); Lixin Ma, Wuhan (CN)

(21) Appl. No.: 19/396,294

(22) Filed: Nov. 20, 2025

(30) Foreign Application Priority Data
Nov. 25, 2024 (CN) 202411688549.4

(51) Int. Cl. G01N 19/02; G01N 1/28; G01N 1/34

(52) U.S. Cl. CPC G01N 19/02; G01N 1/286; G01N 1/34

(57) ABSTRACT

A characterization protection method for a transfer film of a ring-block friction pair is provided, and relates to the technical field of friction testing. By utilizing a frame-shaped protective tape, the method effectively protects the transfer film on the surface of the friction pair, prevents contamination of the surface by the cutting fluid during the cutting process, and ensures the structural integrity of the transfer film and the analysis of composition and bonding structure of the transfer film. Depending on the test environmental conditions, the thickness and material of the functional layer are adjusted and optimized, thereby effectively maintaining the original state of the region to be analyzed on the ring specimen after the friction test under various test environmental conditions. This ensures more accurate results of subsequent characterization analyses and facilitates a more in-depth analysis of the ring-block friction and wear mechanisms under different working conditions.

### CROSS-REFERENCE TO RELATED APPLICATION

This application claims priority to Chinese Patent Application No. 202411688549.4, filed Nov. 25, 2024, which is herein incorporated by reference in its entirety.

### TECHNICAL FIELD The disclosure relates to the technical field of friction testing, and more particularly to a characterization protection method for a transfer film of a ring-block friction pair.

### BACKGROUND

A friction pair refers to the contacting surfaces of two bodies in relative motion where friction and wear occur. Selecting an appropriate friction-pair material can slow the wear process, prolong component life, and thereby reduce maintenance costs. During friction, wear debris generated from polymeric materials is transferred to the metallic surface, where a series of physical and chemical processes form a thin film known as a transfer film. In tribological research, the ring-block friction test is a widely used method for evaluating the friction and wear performance of materials under rotational motion. To gain an in-depth understanding of the friction and wear mechanisms, the transfer film adhered to the worn surface of a ring specimen (i.e., the circumferential surface of the ring specimen) must be characterized in detail with respect to its composition and structure, typically by means of scanning electron microscopy (SEM), X-ray diffraction (XRD), and X-ray photoelectron spectroscopy (XPS) etc. However, these characterization techniques impose strict limitations on sample dimensions; for example, some XRD analytical chambers require a sample height of no more than 15 millimeters (mm), whereas the diameter of the ring specimen for the friction testing is usually at least 50 mm. Consequently, the ring specimen cannot be inserted directly into the XRD chambers for analysis and characterization.

To solve this problem, operators usually need to cut the ring specimen to meet the dimensional requirements of the analytical instrument. The wire-cut technology is commonly used for the cutting. Although the wire-cut technology achieves high precision by locally melting the metal with spark discharges, the use of coolant (cutting fluid) is required to prevent overheating. The transfer film is normally very thin and fragile, and can easily be damaged by external force or environmental influences. Moreover, the cutting fluid has a complex chemical composition and a certain degree of solubility, which may dissolve or lift the film, thereby affecting the fixation effect of the transfer film generated on the surface of the ring specimen. The cutting fluid has complex composition, and contains various organic solvents. If the transfer film attached to the circumferential surface of the ring specimen is not protected before direct wire-cutting processing, it may cause contamination of the specimen surface, thereby affecting the accuracy of subsequent characterization. In practice, technicians often wrap the specimen with adhesive tape to block contamination. However, such an approach is rudimentary and cannot fully preserve the structural integrity of the transfer film. Furthermore, in friction testing, the test environmental conditions are constantly changing, making a single protection method increasingly inadequate to meet the testing requirements under various application conditions. These technical challenges hinder the analysis of the composition and bonding structure of the transfer film, as well as a deeper analysis of the friction and wear mechanism of the ring block under different working conditions.

Consequently, it has become a significant technical challenge in tribology research that how to effectively protect the circumferential surface of the ring specimen from contamination by the wire-cutting fluid during the cutting process, so that the final characterization test results can truly reflect the element types and friction-chemical mechanisms on the worn surface of the ring specimen.

### SUMMARY

In view of the above shortcomings in the related art, in a first aspect of the disclosure, a characterization protection method for a transfer film of a ring-block friction pair, which exhibits strong protective capability and broad applicability, including the following steps:
using a frame-shaped protective tape to protect the transfer film of the ring-block friction pair on the ring specimen in a cutting process of a ring specimen.

The frame-shaped protective tape includes a three-layer composite structure consisting of a protective layer, a functional layer, and an adhesive layer sequentially.

The functional layer is a functional tape with a thickness and a material adjusted according to a test environmental condition.

The adhesive layer includes: an inner region and an outer region. The outer region is an adhesive glue and configured to be contacted and fixed to two end surfaces of the ring specimen via adhesiveness. The inner region is a recess region without an adhesive glue in the adhesive layer, and configured to cover a worn surface to be analyzed in the transfer film of the ring-block friction pair.

The material selection for the protective layer is diverse, and the material with protective and isolating effects against the cooling fluid, such as a waterproof tape, can be used. The position of the inner region of the adhesive layer can be adjusted accordingly, and those skilled in the art can determine the appropriate size, shape, and distribution of the inner region based on the scope of the actual surface to be protected.

In an embodiment, the test environmental condition includes: a seawater environment, a low-speed and low-load condition, and a high-temperature environment.

In an embodiment, the test environmental condition is the seawater environment, and a seawater concentration is classified as one of a low concentration, a medium concentration, and a high concentration; the low concentration simulates natural seawater, with a sodium chloride (NaCl) concentration less than 3.5 weight percent (wt. %); the medium concentration simulates a high-salinity sea area, with a NaCl concentration in a range of 3.5 wt. % to 5.0 wt. %; and the high concentration simulates an extreme saltwater environment, with a NaCl concentration greater than 5.0 wt. %.

A thickness of the functional layer is in a range of 2.0 millimeters (mm) to 3.5 mm, and a material composition of the functional layer includes a resin matrix, a water-absorbing agent, and a chloride-ion absorbent.

In an embodiment, when the seawater concentration is the low concentration, a weight ratio of the resin matrix, the water-absorbing agent, and the chloride-ion absorbent is in a range of 88-92:5:3-7; when the seawater concentration is the medium concentration, a weight ratio of the resin matrix, the water-absorbing agent, and the chloride-ion absorbent is in a range of 83-87:5:8-12; and when the seawater concentration is the high concentration, a weight ratio of the resin matrix, the water-absorbing agent, and the chloride-ion absorbent is in a range of 78-82:5:13-17.

Conventional protective measures are difficult to meet the test requirements of the seawater environments, primarily due to the following technical issues.

1. Ion contamination: Ionic components in seawater (such as chloride ions, abbreviated as Cl-) may react with the specimen material, leading to changes in the chemical composition of the transfer film surface, which can affect the results of subsequent characterization analyses.

2. Hydrate formation: In high-humidity environments, additional hydrates may form on the surface of the friction specimen, potentially influencing the assessment of the friction characteristics and wear behavior of the actual ring-block friction pair materials.

Therefore, the disclosure adjusts the proportion of the chloride ion absorbent in the functional layer material according to varying concentrations of salt ions in seawater during the friction test, thereby preventing the degradation of the transfer film caused by residual Cl-. Additionally, the water-absorbing agent is employed to avoid the formation of a high-humidity environment within the frame-shaped protective tape.

In an embodiment, the resin matrix includes one selected from the group consisting of polyurethane, epoxy resin, and polyvinylidene fluoride; the water-absorbing agent includes one selected from the group consisting of sodium polyacrylate, polyvinyl alcohol, and cellulose derivatives; and the chloride-ion absorbent includes one selected from the group consisting of a hydroxide-type strong base anion exchange resin, a quaternary ammonium-type cation adsorption resin, and zinc oxide nanoparticles.

In an embodiment, the test environmental condition is the low-speed and low-load condition, a speed for the low-speed and low-load condition is in a range of 0 revolution per minute (rpm) to 100 rpm, a load for the low-speed and low-load condition is in a range of 0 newton (N) to 50 N, and a thickness of the functional layer is in a range of 0.5 mm to 1.5 mm.

When the friction condition of the ring-block friction pair is the low-speed and low-load condition, the transfer film obtained is typically thin (with a thickness within a few micrometers) due to the low-speed and low-load friction condition. An excessively thick functional layer can induce stress concentration in weaker regions of the transfer film, thereby causing damage to the transfer film. Therefore, based on the testing application requirements of the disclosure, the thickness of the functional layer should be controlled within the range of 0.5-1.5 mm. The disclosure avoids applying excessive pressure to the fragile areas of the transfer film by regulating the optimal thickness of the functional layer, thereby preventing damage to the transfer film. It should be particularly noted that this parameter is determined according to the inventor's specific design process and is not a conventional choice for those skilled in the art.

Through experiments, the thickness of the transfer film is measured under various friction conditions. For example, when the rotational speed is 50 rpm and the normal load is 20 N, the average thickness of the transfer film is X micrometers (μm); whereas when the rotational speed is 100 rpm and the normal load is 50 N, the average thickness is Y μm. Subsequently, linear regression analysis is employed to establish a relational expression between the thickness of the transfer film and the thickness of the functional layer, expressed as T_{transfer}=k×T_{function}+b, where T_{transfer} represents the thickness of the transfer film, T_{function} represents the thickness of the functional layer, and k and b represents undetermined parameters.

When analyzing the influence of pressure, the formula P=F/A is used to calculate the pressure, where P represents the pressure acting on the transfer film, F represents the applied force, and A represents the contact area. The contact area can be calculated based on the diameter (d) of the ring and the thickness of the functional layer, specifically as A=π×d×T_{function}, thereby enabling the calculation of the corresponding contact area for different functional layer thicknesses. For the quantification of softness, Shore A hardness is selected as the evaluation criterion to record the hardness values of different materials, and is correlated with the performance under the low-speed and low-load condition. The softness of the material is quantified using the formula: Softness Index=1/Hₛₕₒᵣₑ, where Hₛₕₒᵣₑ represents the Shore A hardness value.

During the pressure analysis, it is ensured that the pressure in the vulnerable areas does not exceed the index parameter specified by the disclosure (less than 50 kilopascals). Based on this, the optimal thickness range of the functional layer is determined, thereby ensuring the stability of the transfer film under the low-speed and low-load condition. Those skilled in the art can also complete further thickness designs under the guidance of this design process.

In an embodiment, the test environmental condition is the high-temperature environment; when a temperature is in a range of 150° C. to 300° C., a material of the functional layer includes one selected from the group consisting of polyimide, polyether ether ketone, and a phenolic resin-based composite material; when the temperature is in a range of 300°° C. to 1000° C., the material of the functional layer includes one selected from the group consisting of ceramic fiber, alumina fiber, or silicon carbide fiber.

When the friction condition of the ring-block friction pair is the high-temperature environment, characterizing the friction product immediately before the friction pair cools down generally allows for a more real-time observation of the physical and chemical state of the material under the high-temperature condition. In such cases, the microscopic morphology and chemical composition of the friction products are more likely to remain in their “original” state. Conversely, when characterization is performed after cooling, changes occur in oxides, thermal decomposition products, and the microscopic structure of the transfer film surface during the cooling process. A decrease in temperature may induce oxidation or structural contraction, leading to deviations in the results of the characterization analysis. Additionally, new oxide layers may form on the surface during cooling, or microscopic morphology changes may result from the release of thermal stresses, thereby affecting the accurate assessment of the true friction behavior of the material.

Under the high-temperature environmental condition, the functional layer material of the disclosure is designed as a thermal insulation layer to mitigate the impact of rapid temperature drops on the structure of the friction product. The function of the thermal insulation layer is to maintain the temperature of the friction surface and reduce the rate of heat conduction during the cooling process, thereby delaying morphological or chemical composition changes caused by cooling. This helps preserve the high-temperature state of the friction product and minimizes the difference in characterization results before and after cooling.

In an embodiment, fold lines are provided on bends where the outer region contacts and secures to the two end surfaces of the ring specimen.

The fold lines enable the tape to better conform to the corner bending areas of the ring specimen, thereby enhancing its adhesive performance, improving the flexibility and adaptability, and preventing the tape from loosening or peeling off at the bends.

In an embodiment, the characterization protection method further includes the following steps in an operational process during a friction test:
(1) mounting the ring specimen and a block specimen into clamps of a test device respectively, and conducting the friction test under preset conditions including a rotational speed, a load, a temperature, and a duration;
(2) removing, after the friction test, the ring specimen, and observing the transfer film on a worn surface of the ring specimen to determine a region to be analyzed, where the region to be analyzed is a region where surface morphology and state differ noticeably from an unworn region and is suitable for further characterization of friction and wear mechanisms;
(3) aligning the inner region of the adhesive layer of the frame-shaped protective tape with the region to be analyzed of the ring specimen to make the inner region cover the worn surface to be analyzed in the transfer film, and adhering the outer region to the two end surfaces of the ring specimen to complete fixation and prevent displacement of the frame-shaped protective tape during the cutting process;
(4) performing a wire-cut operation along an outer contour of the frame-shaped protective tape to obtain a piece (i.e., a small piece) of the ring specimen, removing the piece of the ring specimen, cleaning the piece of the ring specimen to remove residual contaminants, and then drying the piece of the ring specimen to obtain a dried piece for further testing; and
(5) removing the frame-shaped protective tape from the dried piece to obtain a tape-removed piece, and conducting a characterization test on the tape-removed piece.

In an embodiment, in step (5), the characterization test includes: SEM analysis, XRD analysis, energy-dispersive spectrometry (EDS) analysis, and XPS analysis.

Based on the above technical solutions, the method of the disclosure effectively protects the transfer film on the surface of the friction pair material by using the frame-shaped protective adhesive tape, prevents contamination of the surface by the cutting fluid during the cutting process, and ensures the structural integrity of the transfer film and the composition and bonding structure analysis of the transfer film. According to different test environmental conditions, the disclosure can effectively maintain the original state of the region to be analyzed on the ring specimen after the friction test under various test environmental conditions by adjusting and optimizing the thickness and material of the second layer, i.e., the functional layer, thereby making subsequent characterization results more accurate and facilitating a deeper analysis of the friction and wear mechanisms of the ring-block pair under different conditions. The method is simple to operate, cost-effective, and suitable for protecting transfer films on ring specimens of various sizes and under various working conditions, and achieves effective protection without affecting the accuracy of friction and wear characterization results.

Compared to the related art, the disclosure has the following advantages and beneficial effects.

The disclosure provides the characterization protection method for the transfer film of the ring-block friction pair. The method offers strong protection and wide applicability, and improves the accuracy of tribological research.

### BRIEF DESCRIPTION OF DRAWINGS

FIG. 1 illustrates a schematic structural diagram of a frame-shaped protective tape.

FIG. 2 illustrates a schematic exploded view of the frame-shaped protective tape.

FIG. 3 illustrates a top view of the frame-shaped protective tape protecting a region to be analyzed of the ring specimen.

FIG. 4 illustrates an overall schematic diagram of the frame-shaped protective tape attached to the ring specimen.

FIG. 5 illustrates a front view of the frame-shaped protective tape attached to the ring specimen.

FIG. 6 illustrates a side view of the frame-shaped protective tape attached to the ring specimen.

FIG. 7 illustrates a diagram of SEM and EDS distributions of a worn surface of a 45-steel (carbon steel with a carbon content of 0.42%-0.50%) ring in a seawater environment without using the frame-shaped protective tape.

FIG. 8 illustrates a diagram of SEM and EDS distributions of a worn surface of a 45-steel ring in the seawater environment using the frame-shaped protective tape.

Description of reference signs: 01: ring specimen; 02: frame-shaped protective tape; 021: inner region; 022: outer region; 023: fold line; 024: region to be analyzed; 025: functional layer; 026: protective layer.

### DETAILED DESCRIPTION OF EMBODIMENTS

The following further illustrates the disclosure through embodiments, but the disclosure is not limited to the scope of the embodiments described. The experimental methods without specific conditions specified in the following embodiments shall be selected according to conventional methods and conditions, or according to the product manual.

### Embodiment 1

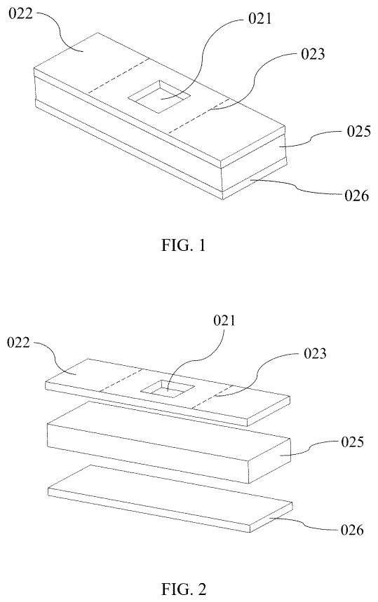

A structure of a frame-shaped protective tape 02 used in the embodiment is shown in FIGS. 1-2. The frame-shaped protective tape 02 is a three-layer composite structure consisting of a protective layer 026, a functional layer 025, and an adhesive layer sequentially. The protective layer 026 is a waterproof adhesive tape. The functional layer 025 is a functional tape (functional adhesive tape) with a thickness and a material adjusted according to a test environmental condition. In this embodiment, it is an ordinary test condition, those skilled in the art can select suitable material and thickness of the functional layer 025 in accordance with actual test requirements. The adhesive layer is divided into an inner region 021 and an outer region 022. Fold lines 023 are provided at bends where the outer region 022 contacts and secures to two end surfaces of the ring specimen 01, facilitating optimizing the fit effect of the bent portion. The inner region 021 is a recessed area in the adhesive layer without the adhesive glue. The outer region 022 is the adhesive glue and configured to be attached to the ring specimen 01 via adhesiveness for fixation.

In this embodiment, the characterization protection method for the transfer film of the ring-block friction pair is applied to a ring specimen 01 with a diameter of 55 mm. The experiment requires EDS analysis of the worn circumferential surface of the ring specimen 01 to evaluate elemental changes on the worn surface. The specific steps are as follows.

(1) The ring specimen 01 and a block specimen are secured into clamps of a friction test device respectively, and the friction test is conducted at a rotational speed of 300 rpm, a normal load of 100 N, and a friction duration of 60 min.

(2) After the friction test, the ring specimen 01 is removed. The wear condition on the surface of the ring specimen 01 is observed, and apparent friction traces are found on the specimen 01. Through preliminary optical microscope observation, an outer region of the ring specimen 01 is determined as a region to be analyzed 024.

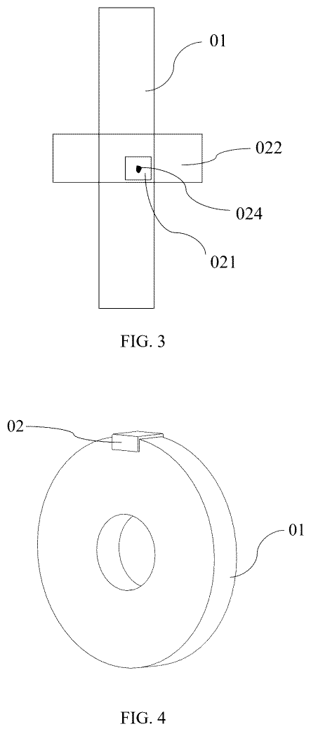

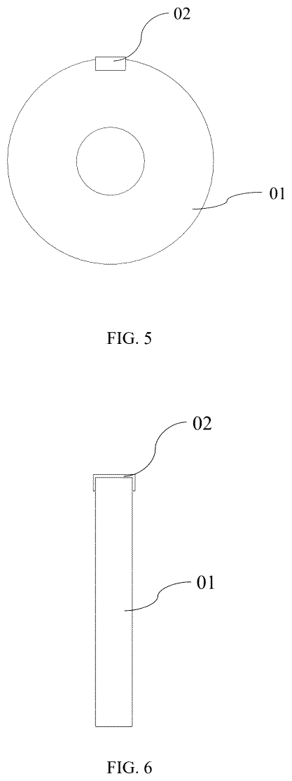

(3) A frame-shaped protective tape 02 is taken with tweezers. As shown in FIG. 3, a center part of the inner region 021 is aligned with the region to be analyzed 024, and the entire frame-shaped protective tape 02 is affixed onto the surfaces of the ring specimen 01. The outer region 022 adheres to the two end surfaces of the ring specimen 01 for fixation, ensuring complete coverage of the friction surface. The schematic diagrams after fixation are shown in FIGS. 4-6.

(4) The ring specimen 01 is secured to a wire-cut machine, and is cut along an outer contour of the frame-shaped protective tape 02 to obtain a piece of the ring specimen 01. Since the frame-shaped protective tape 02 effectively isolates the cutting fluid, no contamination occurs during the cutting process. After cutting is complete, the surface of the piece of the ring specimen 01 is rinsed with deionized water to remove residual cutting fluid and impurities, and then the piece of the ring specimen 01 is dried in preparation for further testing.

(5) The frame-shaped protective tape 02 is removed, and an analysis of the elemental valence states on the specimen surface is performed using XPS. It is found that the elemental valence states and distribution on the surface correspond with the wear situation under actual dry friction conditions, unaffected by additional chemical elements from the cutting fluid used during the cutting process.

### Embodiment 2

The frame-shaped protective tape 02 used in this embodiment is substantially identical to that in the embodiment 1, with the only difference being that the composition of the functional layer 025 in this embodiment includes polyurethane, sodium polyacrylate, and a hydroxide-type strong base anion exchange resin, in a weight ratio of 90:5:5. During testing, those skilled in the art can flexibly select the specific components and their ratios for the corresponding functional layer 025 according to the testing requirements of the seawater environmental conditions, and the concentration classifications and corresponding parameters defined in the disclosure.

The embodiment applies the characterization protection method for the transfer film of the ring specimen 01 in the seawater environment, investigating the friction performance of the ring specimen 01 under seawater and high load conditions. The experimental environment simulates marine conditions, with the friction pair material being the marine coating material. A ring specimen 01 and a block counter material are used during the experiment, and the characterization analysis is performed on the specimen surface after the test. The specific steps are as follows.

(1) The friction test device is set at a normal-temperature environment at 25° C., with a normal load of 500 N. A seawater solution with a standard concentration is used to simulate the marine environment. The ring specimen 01 and the block specimen are secured into the clamps of the friction test device respectively. The friction test is conducted under the set seawater and high-load condition for a duration of 60 min.

(2) After the friction test, the ring specimen 01 is removed, and a blower is used to dry the seawater adsorbed on its surface until the surface is in a dry state. The surface of the ring specimen is observed using an optical microscope and the wear condition on the surface of the ring specimen (01) is observed. It is found that the wear under the high-load condition is more pronounced. A region on the ring specimen 01 with significant wear traces is determined as the region to be analyzed 024.

(3) The frame-shaped protective tape 02 is taken with tweezers. a center part of the inner region 021 is aligned with the region to be analyzed 024, and the entire frame-shaped protective tape 02 is affixed onto the surfaces of the ring specimen 01. The outer region 022 adheres to the two end surfaces of the ring specimen 01 for fixation, ensuring complete coverage of the friction surface.

(4) The ring specimen 01 is secured to the wire-cut machine, and is cut along the outer contour of the frame-shaped protective tape 02 to obtain a piece of the ring specimen 01. After cutting is complete, the surface of the piece of the ring specimen 01 is rinsed with deionized water to remove residual cutting fluid and impurities, and then the piece of the ring specimen 01 is dried in preparation for further testing.

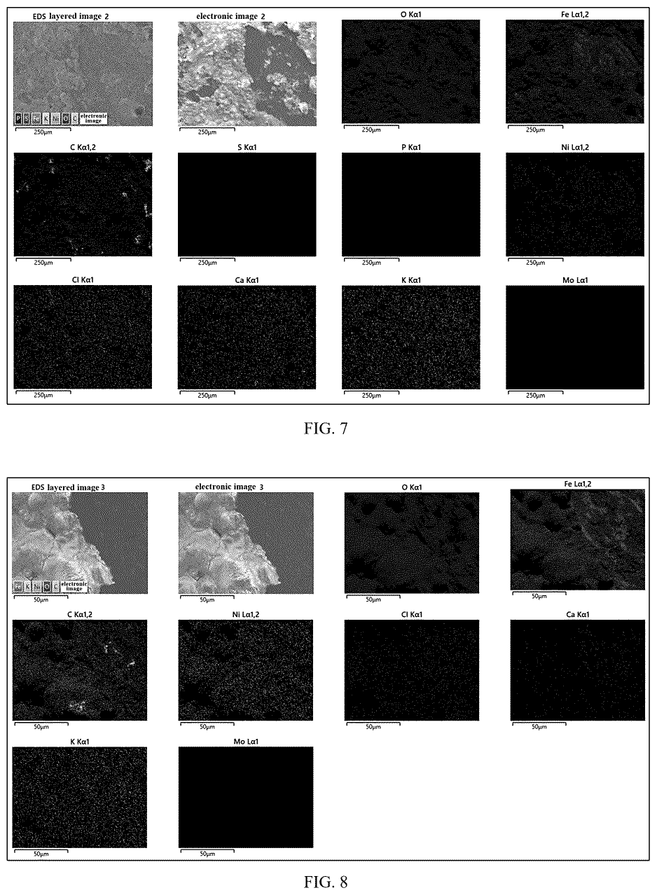

(5) The frame-shaped protective tape 02 is removed from the piece of the ring specimen 01, and an analysis is performed on the piece of the ring specimen 01 using EDS. The results indicate that the friction surface is uncontaminated. As shown in FIG. 7, FIG. 7 shows the SEM image and EDS distribution of the worn surface of a 45-steel ring specimen in a seawater environment without the use of the frame-shaped protective tape 02. FIG. 8 shows the SEM image and EDS elemental distribution of the worn surface of a 45-steel ring specimen in the seawater environment with the use of the frame-shaped protective tape 02. A comparison between FIG. 7 and FIG. 8 reveals that when the frame-shaped protective tape 02 is not used, elements such as phosphorus (P) and sulfur(S) from the cutting fluid contaminate the surface of the 45-steel ring specimen. In contrast, when the frame-shaped protective tape 02 is used, the intrusion of the cutting fluid is effectively prevented, and no contaminating elements like P or S are detected. The analysis results accurately reflect the true friction and wear condition of the material.

This embodiment demonstrates that the method of the disclosure can effectively prevent contamination of the transfer film on the worn surface of the ring specimen 01 from the cutting fluid during the wire-cutting process in the marine environment, thereby ensuring the accuracy of subsequent characterization analysis.

### Embodiment 3

The frame-shaped protective tape 02 used in this embodiment is substantially identical to that in the embodiment 1, with the only difference being that the thickness of the functional layer 025 is controlled within the design range corresponding to the low-speed and low-load working condition. In this embodiment, the specimen is tested in a normal temperature environment, primarily to investigate the wear behavior and surface characteristics under low friction speed (low-speed and low-load) conditions. The specific steps are as follows.

(1) The ring specimen 01 with a diameter of 60 mm and a corresponding block specimen are secured to the friction test device, and the friction test is conducted at a rotational speed of 50 rpm, a normal load of 50 N, a temperature of 25° C., and a duration of 60 min.

(2) After the friction test, the surface of the ring specimen 01 is observed through a microscope. A portion where the friction region and the unworn region show a clear difference as a region to be analyzed 024.

(3) The frame-shaped protective tape 02 is taken with tweezers. A center part of the inner region 021 is aligned with the region to be analyzed 024, and the frame-shaped protective tape 02 is affixed onto the surface of the ring specimen 01 to ensure complete coverage of the friction surface.

(4) The ring specimen 01 is cut by the wire-cut machine along an outer contour of the frame-shaped protective tape 02 to thereby obtain a piece of the ring specimen 01, and it is ensured that the cutting fluid does not contact the worn region. The surface of the piece of the ring specimen 01 is rinsed with deionized water, and then the piece of the ring specimen 01 is dried in preparation for further testing.

(5) The frame-shaped protective tape 02 is removed, the phase composition of the specimen surface is analyzed using XRD. The results indicate that the friction surface is uncontaminated by the cutting fluid, and the test results are accurate.

This embodiment demonstrates that under the low-speed and low-load condition, the method of the disclosure effectively isolates contamination from the cutting fluid, thereby ensuring high reliability in the subsequent XRD characterization analysis.

### Embodiment 4

The frame-shaped protective tape 02 used in this embodiment is substantially identical to that in the embodiment 1, with the only difference being that the functional layer 025 in this embodiment is made of polyimide (polyether ether ketone or phenolic resin-based composite materials can also achieve the objectives of this embodiment; when the temperature is higher, technical personnel may select ceramic fiber, alumina fiber, or silicon carbide fiber) to meet the testing requirements of the high-temperature environmental condition. This embodiment investigates the wear behavior and surface characteristics of the ring specimen 01 under the high-temperature and high-load condition, with the specific steps as follows.

(1) The ring specimen 01 with a diameter of 55 mm and a block specimen are mounted into clamps of a high-temperature friction test device respectively, and the friction test is conducted at a rotational speed of 200 rpm, a normal load of 500 N, a temperature of 250° C., and a friction duration of 60 min.

(2) After the friction test, the ring specimen 01 is removed. The transfer film on the worn surface of the ring specimen 01 is observed, and the region with severe wear is selected as a region to be analyzed 024.

(3) The frame-shaped protective tape 02 is taken with tweezers. A center part of the inner region 021 is aligned with the region to be analyzed 024, and the frame-shaped protective tape 02 is affixed onto the surface of the ring specimen 01 to ensure complete coverage of the friction surface.

(4) The ring specimen 01 is cut by the wire-cut machine along a contour of the frame-shaped protective tape 02 to thereby obtain a piece of the ring specimen 01, and it is ensured that the cutting fluid does not contact the worn region. The surface of the piece of the ring specimen 01 is rinsed with deionized water, and then the piece of the ring specimen 01 is dried in preparation for further testing.

(5) The surface morphology of the piece of the ring specimen 01 is analyzed using SEM. The results show that the worn surface is uncontaminated, with a clear surface structure.

This embodiment demonstrates that under high-temperature and high-load condition, the protective measure remains effective, ensuring the integrity and cleanliness of the specimen surface. The characterization results accurately reflect the material's high-temperature wear behavior.

In summary, the characterization protection method for the transfer film of the ring-block friction pair according to the disclosure can effectively prevent the transfer film generated by friction on the surface of the ring specimen from being contaminated by the cutting fluid during the wire-cutting process. Particularly under extreme conditions such as high temperature, low-speed and low-load, and seawater environments, the method can still maintain the integrity and the authenticity of the structure and the compositional of the transfer film on the specimen surface, ensuring the accuracy of the subsequent characterization analysis results.

The above provides a detailed description of the exemplary embodiments of the disclosure. It should be understood that those skilled in this field can make many modifications and changes based on the concept of the disclosure without creative labor. Therefore, any technical solution that can be obtained by a person skilled in the art based on the concept of the disclosure through logical analysis, reasoning, or limited experiments on the basis of existing technology should be within the scope of protection determined by the claims.

1. A characterization protection method for a transfer film of a ring-block friction pair, comprising:
using a frame-shaped protective tape (02) to protect the transfer film of the ring-block friction pair on the ring specimen (01) in a cutting process of a ring specimen (01), wherein the frame-shaped protective tape (02) comprises a three-layer composite structure consisting of a protective layer (026), a functional layer (025), and an adhesive layer sequentially; the functional layer (025) is a functional tape with a thickness and a material adjusted according to a test environmental condition; the adhesive layer comprises: an inner region (021) and an outer region (022); the outer region (022) is an adhesive glue and configured to be contacted and fixed to two end surfaces of the ring specimen (01) via adhesiveness; and the inner region (021) is a recess region without an adhesive glue in the adhesive layer, and configured to cover a worn surface to be analyzed in the transfer film of the ring-block friction pair;
wherein the characterization protection method further comprises the following steps in an operational process during a friction test:
(1) mounting the ring specimen (01) and a block specimen into clamps of a test device respectively, and conducting the friction test under preset conditions comprising a rotational speed, a load, a temperature, and a duration;
(2) removing, after the friction test, the ring specimen (01), and observing the transfer film on a worn surface of the ring specimen (01) to determine a region to be analyzed (024), wherein the region to be analyzed (024) is a region where surface morphology and state differ noticeably from an unworn region and is suitable for further characterization of friction and wear mechanisms;
(3) aligning the inner region (021) of the adhesive layer of the frame-shaped protective tape with the region to be analyzed (024) of the ring specimen (01) to make the inner region (021) cover the worn surface to be analyzed in the transfer film, and adhering the outer region (022) to the two end surfaces of the ring specimen (01) to complete fixation and prevent displacement of the frame-shaped protective tape during the cutting process;
(4) performing a wire-cut operation along an outer contour of the frame-shaped protective tape to obtain a small piece of the ring specimen (01), removing the small piece of the ring specimen (01), cleaning the small piece of the ring specimen (01) to remove residual contaminants, and then drying the small piece of the ring specimen (01) to obtain a dried piece for further testing; and
(5) removing the frame-shaped protective tape from the dried piece to obtain a tape-removed piece, and conducting a characterization test on the tape-removed piece.

2. The characterization protection method for the transfer film of the ring-block friction pair as claimed in claim 1, wherein the test environmental condition comprises: a seawater environment, a low-speed and low-load condition, and a high-temperature environment.

3. The characterization protection method for the transfer film of the ring-block friction pair as claimed in claim 2, wherein the test environmental condition is the seawater environment, and a seawater concentration is classified as one of a low concentration, a medium concentration, and a high concentration; the low concentration simulates natural seawater, with a sodium chloride (NaCl) concentration <3.5 weight percent (wt. %); the medium concentration simulates a high-salinity sea area, with a NaCl concentration in a range of 3.5 wt. % to 5.0 wt. %; the high concentration simulates an extreme saltwater environment, with a NaCl concentration >5.0 wt. %; and a thickness of the functional layer (025) is in a range of 2.0 millimeters (mm) to 3.5 mm, and a material composition of the functional layer (025) comprises a resin matrix, a water-absorbing agent, and a chloride-ion absorbent.

4. The characterization protection method for the transfer film of the ring-block friction pair as claimed in claim 3, wherein when the seawater concentration is the low concentration, a weight ratio of the resin matrix, the water-absorbing agent, and the chloride-ion absorbent is in a range of 88-92:5:3-7; when the seawater concentration is the medium concentration, a weight ratio of the resin matrix, the water-absorbing agent, and the chloride-ion absorbent is in a range of 83-87:5:8-12;
and when the seawater concentration is the high concentration, a weight ratio of the resin matrix, the water-absorbing agent, and the chloride-ion absorbent is in a range of 78-82:5:13-17.

5. The characterization protection method for the transfer film of the ring-block friction pair as claimed in claim 3, wherein the resin matrix comprises one selected from the group consisting of polyurethane, epoxy resin, and polyvinylidene fluoride; the water-absorbing agent comprises one selected from the group consisting of sodium polyacrylate, polyvinyl alcohol, and cellulose derivatives; and the chloride-ion absorbent comprises one selected from the group consisting of a hydroxide-type strong base anion exchange resin, a quaternary ammonium-type cation adsorption resin, and zinc oxide nanoparticles.

6. The characterization protection method for the transfer film of the ring-block friction pair as claimed in claim 2, wherein the test environmental condition is the low-speed and low-load condition, a speed for the low-speed and low-load condition is in a range of 0 revolution per minute (rpm) to 100 rpm, a load for the low-speed and low-load condition is in a range of 0 newton (N) to 50 N, and a thickness of the functional layer (025) is in a range of 0.5 mm to 1.5 mm.

7. The characterization protection method for the transfer film of the ring-block friction pair as claimed in claim 2, wherein the test environmental condition is the high-temperature environment;
when a temperature is in a range of 150° C. to 300° C., a material of the functional layer (025) comprises one selected from the group consisting of polyimide, polyether ether ketone, and a phenolic resin-based composite material; when the temperature is in a range of 300° C. to 1000° C., the material of the functional layer (025) comprises one selected from the group consisting of ceramic fiber, alumina fiber, or silicon carbide fiber.

8. The characterization protection method for the transfer film of the ring-block friction pair as claimed in claim 1, wherein fold lines (023) are provided on bends where the outer region (022) contacts and secures to the two end surfaces of the ring specimen (01).

9. The characterization protection method for the transfer film of the ring-block friction pair as claimed in claim 1, wherein in step (5), the characterization test comprises: scanning electron microscopy analysis, X-ray diffraction analysis, energy-dispersive spectrometry analysis, and X-ray photoelectron spectroscopy analysis.
